(19) United States
(12) Patent Application Publication
(10) Pub. No.: US 2024/0137869 A1
(43) Pub. Date: Apr. 25, 2024

(54) TECHNIQUES FOR INDICATING SKIPPING A DISCONTINUOUS RECEIVE ACTIVE DURATION IN WIRELESS COMMUNICATIONS

(71) Applicant: QUALCOMM Incorporated, San Diego, CA (US)

(72) Inventors: Ahmed ELSHAFIE, San Diego, CA (US); Diana Maamari, San Diego, CA (US); Huilin Xu, Temecula, CA (US)

(21) Appl. No.: 18/048,309

(22) Filed: Oct. 19, 2022

(51) Int. Cl. H04W 52/02; H04W 72/04

(52) U.S. Cl. CPC H04W 52/0235; H04W 72/042

(57) ABSTRACT

Aspects described herein relate to receiving, during a discontinuous receive (DRX) active time, a go to sleep (GTS) signal in a group-based downlink control information (DCI) indicating to enter a sleep mode at the UE, and entering, based on receiving the GTS signal, the sleep mode during at least a period of a remaining portion of the DRX active time. Other aspects relate to transmitting the GTS signal.

### FIELD OF THE DISCLOSURE

Aspects of the present disclosure relate generally to wireless communication systems, and more particularly, to techniques for using discontinuous receive (DRX).

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a processor, memory coupled with the processor, and instructions stored in the memory. The instructions are operable, when executed by the processor, to cause the apparatus to receive, during a discontinuous receive (DRX) active time, a go to sleep (GTS) signal in a group-based downlink control information (DCI) indicating to enter a sleep mode at the apparatus, and enter, based on receiving the GTS signal, the sleep mode during at least a period of a remaining portion of the DRX active time.

In another aspect, an apparatus for wireless communication is provided that includes a processor, memory coupled with the processor, and instructions stored in the memory. The instructions are operable, when executed by the processor, to cause the apparatus to configure a user equipment (UE) to communicate in a DRX active time, and transmit, during the DRX active time, a GTS signal in a group-based DCI indicating to enter a sleep mode at the UE.

In another aspect, a method for wireless communication at a UE is provided that includes receiving, during a DRX active time, a GTS signal in a group-based DCI indicating to enter a sleep mode at the UE, and entering, based on receiving the GTS signal, the sleep mode during at least a period of a remaining portion of the DRX active time.

In another aspect, a method for wireless communication at a network node is provided that includes configuring a UE to communicate in a DRX active time, and transmitting, during the DRX active time, a GTS signal in a group-based DCI indicating to enter a sleep mode at the UE.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE), in accordance with various aspects of the present disclosure;

FIG. 4 is a block diagram illustrating an example of a base station, in accordance with various aspects of the present disclosure;

FIG. 5 is a flow chart illustrating an example of a method for skipping at least a period of a remaining portion of a discontinuous receive (DRX) active time, in accordance with aspects described herein;

FIG. 6 is a flow chart illustrating an example of a method for configuring a device to skip at least a period of a remaining portion of a DRX active time, in accordance with aspects described herein;

FIG. 7 illustrates an example of a timeline of multiple DRX cycles, in accordance with aspects described herein;

FIG. 8 illustrates an example of a timeline of multiple DRX cycles for multiple groups of UEs, in accordance with aspects described herein; and

FIG. 9 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to discontinuous receive (DRX) operations in wireless communications, and skipping a DRX active duration, or a remaining portion thereof, to improve device power consumption. In some wireless communication technologies, such as fifth generation (5G) new radio (NR), devices, such as user equipment (UEs), can be configured for connected mode DRX (CDRX) based on a DRX period having a DRX active duration (or ON duration) and a DRX inactive duration (or OFF duration). During the configured DRX active duration, the UE can have active power to certain resources, such as radio frequency (RF) components, power amplifiers, baseband processors, etc., and the UE can deactivate or reduce power to these component during the DRX inactive duration to conserve power. As such, the UE may not expect to receive or be scheduled to transmit communications during the DRX inactive duration. In 5G NR for example, the network (e.g., a network node) can configure the UE with the parameters defining the DRX period, such as a DRX cycle duration, a DRX ON duration within the DRX cycle, etc.

In addition, in 5G NR for example, the network can transmit a wake-up signal (WUS) to the UE during CDRX (e.g., before or at the beginning of the DRX ON duration) to communicate to the UE whether to wake up (e.g., activate resources) during the next DRX ON duration to prepare for data reception. In this example, the UE monitors for the WUS in a time period before activating resources during the DRX ON duration, and as such, the UE may not need to activate resources during the full DRX ON duration, which can facilitate further power savings at the UE. The WUS payload can indicate to wake up (e.g., activate resources for the DRX active duration) or to continue sleeping (e.g., maintain a low or no power state for the resources during the DRX active duration). In an example, the network can configure the UE with information regarding the WUS (e.g., time/frequency location) via radio resource control (RRC) signaling.

In an example, the network can transmit the WUS as a downlink control information (DCI) of a certain format, which can include a group common DCI, such as DCI 2_6 defined in 5G NR. A UE configured with DRX mode operation can be provided certain parameters for detection of a DCI format 2_6 in a physical downlink control channel (PDCCH) reception on a cell (e.g., a primary cell (PCell) or on a secondary cell group (SCG) primary cell (SpCell)): a power saving (PS)-radio network temporary identifier (RNTI) for DCI format 2_6; a number of search space sets to monitor PDCCH for detection of DCI format 2_6 on the active downlink (DL) bandwidth part (BWP) of the PCell or of the SpCell according to a common search space; a payload size for DCI format 2_6; a location in DCI format 2_6 of a wake-up indication bit, where a ‘0’ value for the Wake-up indication bit, when reported to higher layers, indicates to not start a timer for the DRX ON duration for a next long DRX cycle, and a ‘1’ value for the Wake-up indication bit, when reported to higher layers, indicates to start to not start a timer for the DRX ON duration for the next long DRX cycle. The WUS DCI 2_6 can be a group based DCI that is used to wake up a group of UEs (e.g., to indicate that the group of UEs is to activate resources during the next DRX active period). UEs can monitor the WUS during DRX inactive duration (e.g., outside of DRX active time).

Aspects described herein relate to providing an indication for a UE to skip at least a period of a remaining portion of a DRX active period, such as by entering a sleep mode or otherwise deactivating or reducing power to resources (e.g., as done for DRX inactive period), where the UE was previously indicated to activate resources for the DRX active period. For example, the network can transmit a signal similar to the WUS to indicate to one or more UEs in a DRX active period to go to sleep (GTS) for at least a period of a remaining portion of the DRX active period, where GTS can refer to the UE deactivating or reducing power to certain resources (e.g., RF components, power amplifiers, baseband processors, etc.), as currently performed when entering a DRX inactive duration. Said differently, a signal indicating GTS (also referred to herein as a GTS signal) can cause the UE to function, during the period of the remaining portion of the DRX active duration, as it would for a DRX inactive duration. For example, the network can indicate certain UEs in the GTS signal for which the network does not schedule any communications for the remaining portion of the DRX active time.

This can result in further power savings for the UE, as the UE can consider at least the period of the remaining portion of the DRX active period as not requiring power to certain components, which can conserve radio resources and UE processing requirements. This can accordingly improve user experience with using the network and/or the UE, etc.

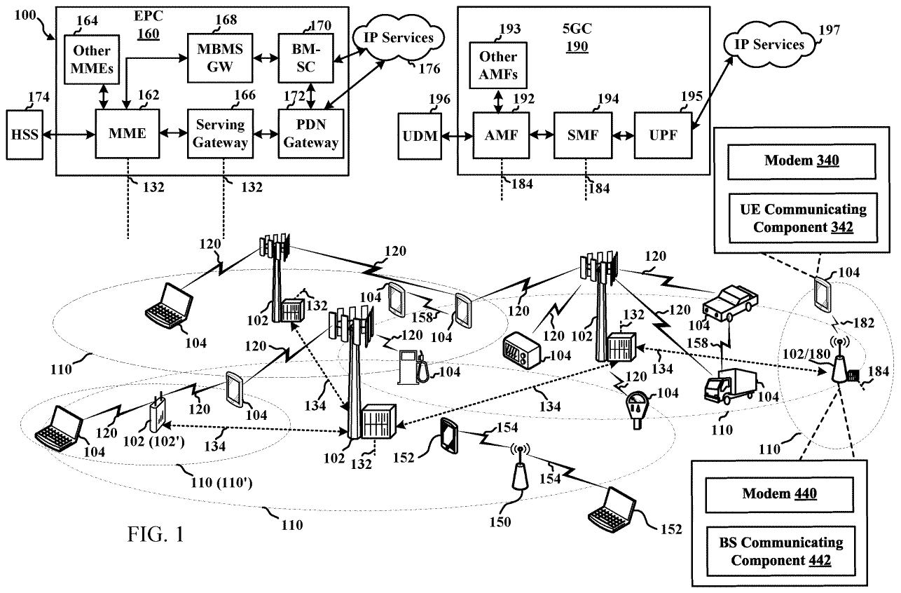

The described features will be presented in more detail below with reference to FIGS. 1-9.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and UE communicating component 342 for receiving an indication to skip at least a period of a remaining portion of a DRX active time, in accordance with aspects described herein. In addition, some nodes may have a modem 440 and BS communicating component 442 for configuring a UE to skip at least a period of a remaining portion of a DRX active time, in accordance with aspects described herein. Though a UE 104 is shown as having the modem 340 and UE communicating component 342 and a base station 102/gNB 180 is shown as having the modem 440 and BS communicating component 442, this is one illustrative example, and substantially any node or type of node may include a modem 340 and UE communicating component 342 and/or a modem 440 and BS communicating component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In an example, UE communicating component 342 can operate in a DRX mode including a DRX active time during which the UE 104 is to have active resources (e.g., RF components, power amplifiers, baseband processors, etc.) to receive and/or transmit communications to a base station 102 or other device. BS communicating component 442 can transmit, and/or UE communicating component 342 can receive, a GTS signal indicating the UE 104 to enter a sleep mode, or otherwise deactivate or decrease power to the resources, during at least a period of a remaining portion of the DRX active time. For example, BS communicating component 442 can transmit, and/or ULE communicating component 342 can receive, the GTS signal during the DRX active time, and UE 104 can accordingly enter the sleep mode for the remainder of the DRX active time. In one example, BS communicating component 442 can transmit, and/or UE communicating component 342 can receive, the GTS signal based on a WUS transmitted by the BS communicating component 442, and/or received by the UE communicating component 342, to activate resources at the UE 104 for the DRX active time.

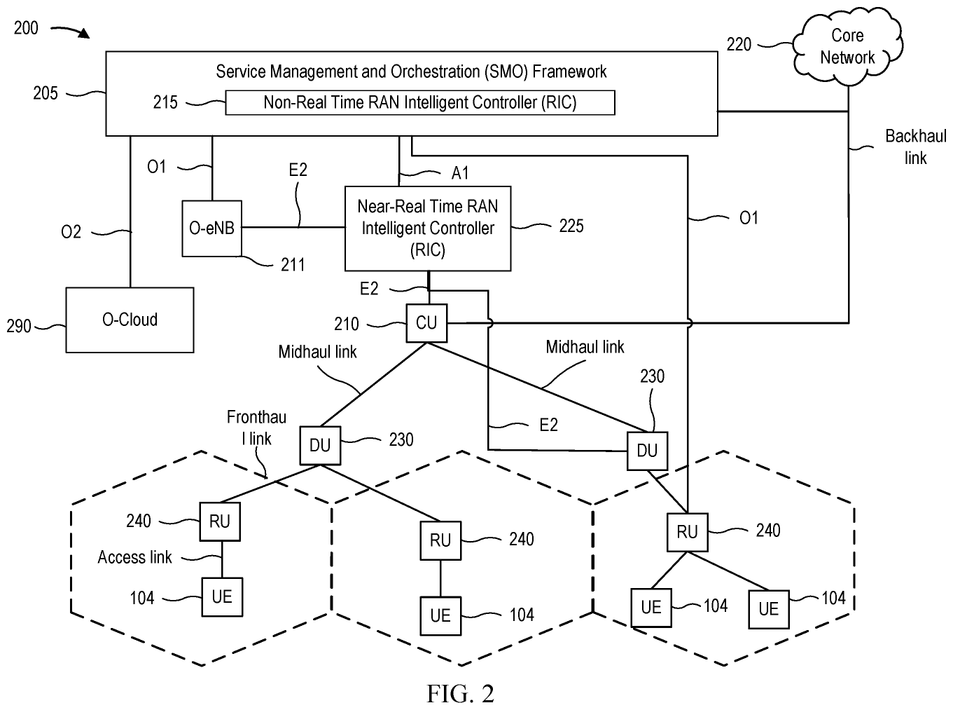

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

In an example, BS communicating component 442, as described herein, can be at least partially implemented within a CU 210, and can transmit a WUS, GTS signal, etc. to UEs via one or more DUs 230, and/or the like. In another example, BS communicating component 442, as described herein, can be at least partially implemented within a DU 230, and can transmit a WUS, GTS signal, etc. to UEs via one or more RUs 240, and/or the like.

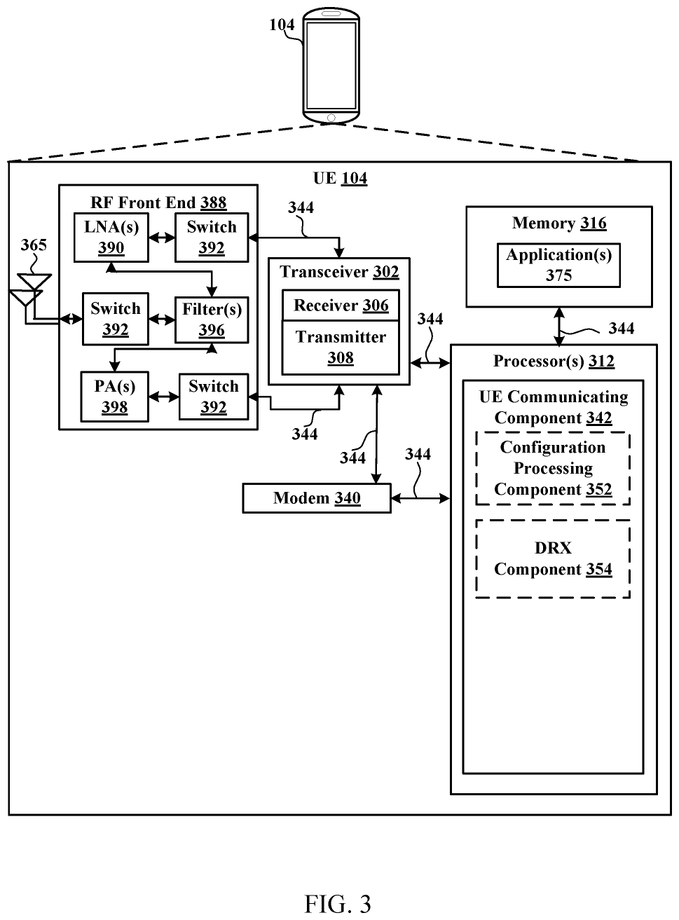

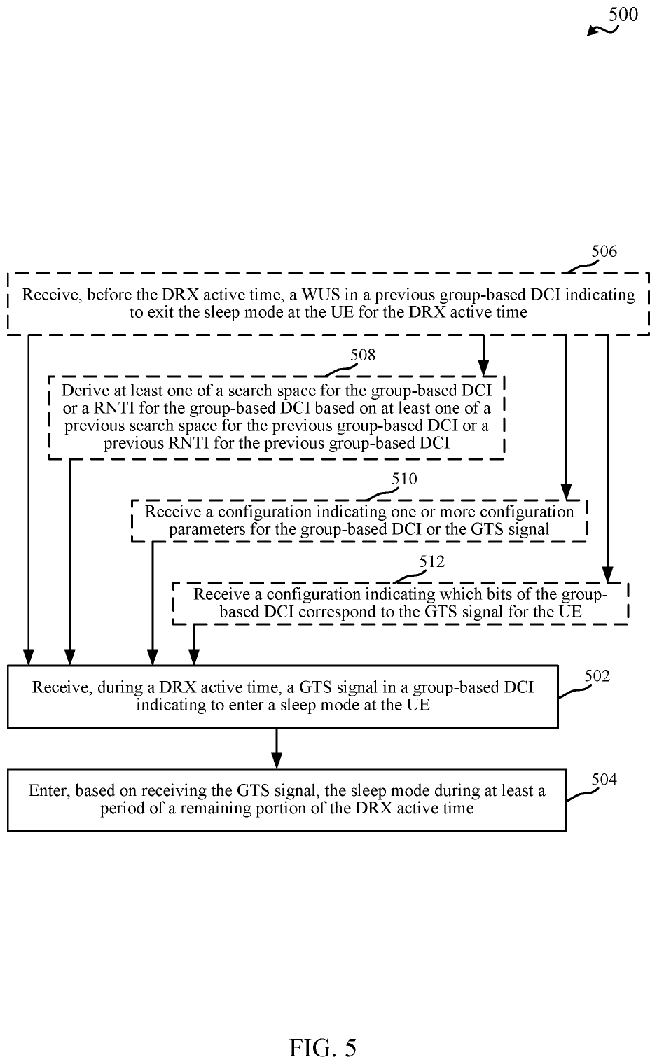

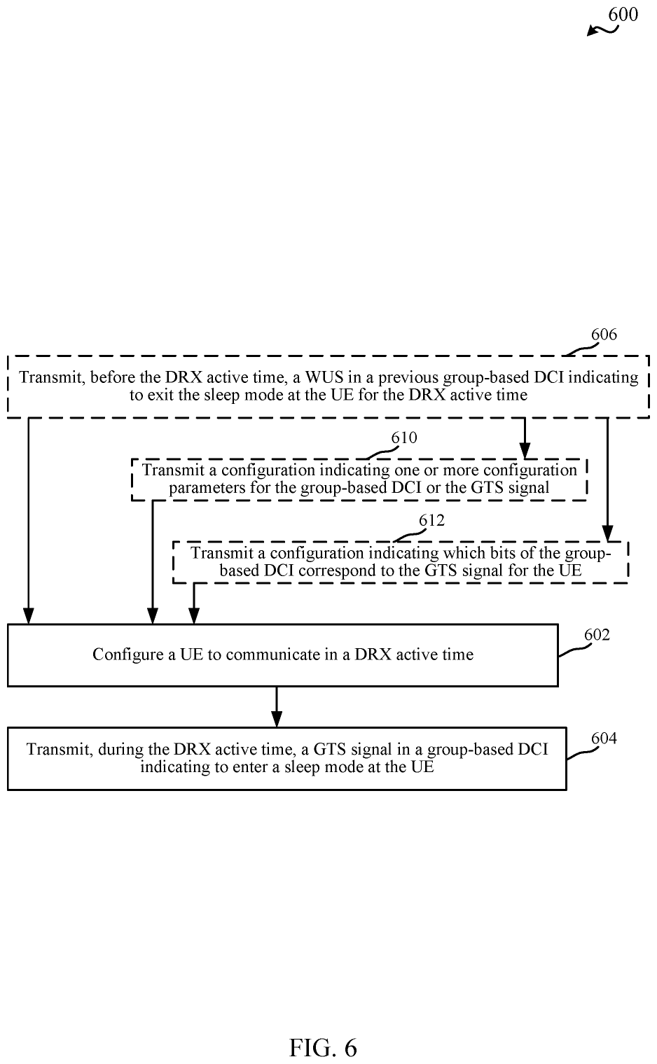

Turning now to FIGS. 3-9, aspects are depicted with reference to one or more components and one or more methods that may perform the actions or operations described herein, where aspects in dashed line may be optional. Although the operations described below in FIGS. 5 and 6 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and memory 316 and transceiver 302 in communication via one or more buses 344, which may operate in conjunction with modem 340 and/or UE communicating component 342 for receiving an indication to skip at least a period of a remaining portion of a DRX active time, in accordance with aspects described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory 316 may be configured to store data used herein and/or local versions of applications 375 or UE communicating component 342 and/or one or more of its subcomponents being executed by at least one processor 312. Memory 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 342 can optionally include an configuration processing component 352 for receiving and/or processing a configuration indicating parameters related to DRX mode, a WUS, a GTS signal, etc., and/or a DRX component 354 for operating a DRX mode, including a DRX active time, which may be based on a received WUS, GTS signal, etc., in accordance with aspects described herein.

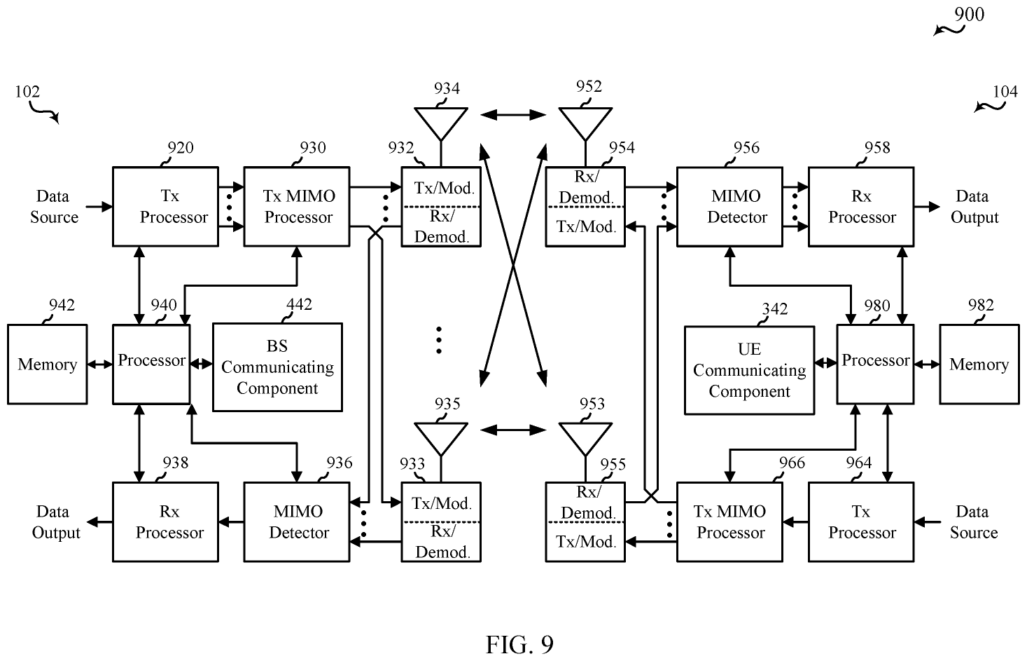

In an aspect, the processor(s) 312 may correspond to one or more of the processors described in connection with the UE in FIG. 9. Similarly, the memory 316 may correspond to the memory described in connection with the UE in FIG. 9.

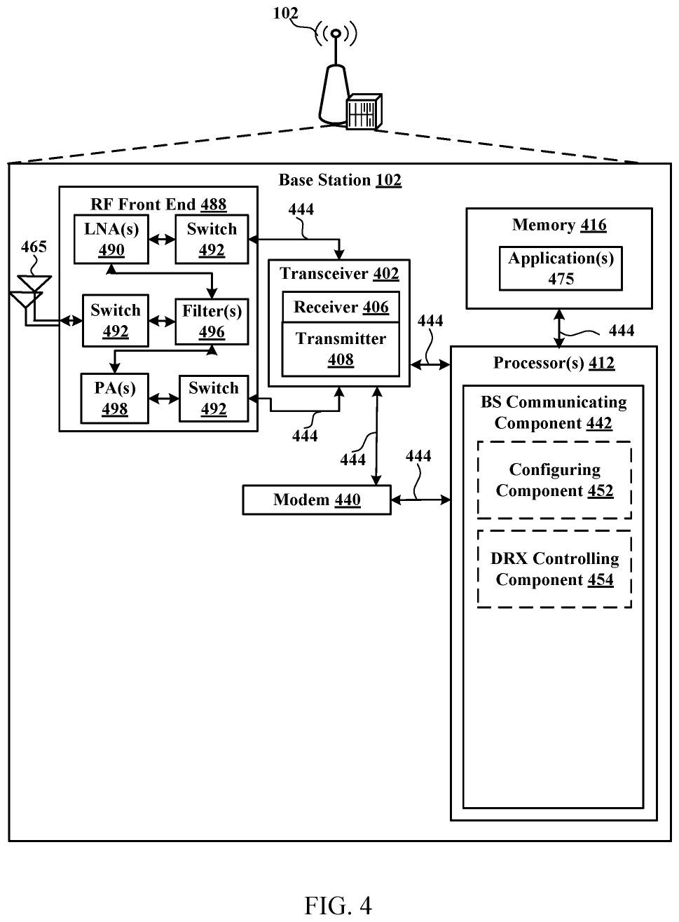

Referring to FIG. 4, one example of an implementation of base station 102 (e.g., a base station 102 and/or gNB 180, as described above) may include a variety of components, some of which have already been described above, but including components such as one or more processors 412 and memory 416 and transceiver 402 in communication via one or more buses 444, which may operate in conjunction with modem 440 and BS communicating component 442 for configuring a UE to skip at least a period of a remaining portion of a DRX active time, in accordance with aspects described herein.

The transceiver 402, receiver 406, transmitter 408, one or more processors 412, memory 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, BS communicating component 442 can optionally include a configuring component 452 for generating and/or transmitting a configuration indicating parameters related to DRX mode, a WUS, a GTS signal, and/or a DRX controlling component 454 for generating and/or transmitting a WUS, GTS signal, etc., in accordance with aspects described herein.

In an aspect, the processor(s) 412 may correspond to one or more of the processors described in connection with the base station in FIG. 9. Similarly, the memory 416 may correspond to the memory described in connection with the base station in FIG. 9.

FIG. 5 illustrates a flow chart of an example of a method 500 for skipping at least a period of a remaining portion of a DRX active time, in accordance with aspects described herein. FIG. 6 illustrates a flow chart of an example of a method 600 for configuring a device to skip at least a period of a remaining portion of a DRX active time, in accordance with aspects described herein. In an example, a UE 104 can perform the functions described in method 500 using one or more of the components described in FIGS. 1 and 3. In an example, a base station 102 (e.g., a gNB, a monolithic base station, a portion of a disaggregated base station, etc.) can perform the functions described in method 600 using one or more of the components described in FIGS. 1 and 4. Methods 500 and 600 are described in conjunction with one another for ease of explanation; however, the methods 500 and 600 are not required to be performed together and indeed can be performed independently using separate devices.

In method 600, at Block 602, a UE can be configured to communicate in a DRX active time. In an aspect, configuring component 452, e.g., in conjunction with processor(s) 412, memory 416, transceiver 402, BS communicating component 442, etc., can configure the UE (e.g., UE 104) to communicate in the DRX active time. For example, configuring component 452 can transmit, to the UE, a DRX configuration related to a DRX mode or DRX cycle, which can include parameters defining the DRX cycle, a DRX active duration during the DRX cycle, etc. For example, configuring component 452 can transmit the DRX configuration in RRC signaling, media access control-control element (MAC-CE), DCI, etc. In one example, configuring component 452 can configure the UE to communicate in the DRX active time by transmitting a WUS indicating the UE to wake up during the DRX active time, as described above and further herein.

In method 600, at Block 604, a GTS signal can be transmitted, during the DRX active time, in a group-based DCI indicating to enter a sleep mode at the UE. In an aspect, DRX controlling component 454, e.g., in conjunction with processor(s) 412, memory 416, transceiver 402, BS communicating component 442, etc., can transmit, during the DRX active time, the GTS signal in the group-based DCI indicating to enter the sleep mode at the UE. For example, DRX controlling component 454 can transmit the GTS signal in a DCI, such as a group-based DCI, to indicate to a subset of one or more UEs that were configured to communicate in the DRX active time to enter the sleep mode (e.g., deactivate or reduce power to certain resources) for at least a period of a remaining portion of the DRX active time. For example, DRX controlling component 454 can transmit the GTS signal to the UE(s) based on determining that no further communications are scheduled for transmitting to, or receiving from, the UE(s) during the DRX active time

In one example, the GTS signal can include a bitmap or other collection of bits, where each bit (or multiple bits) can correspond to one of multiple UEs, and where the bit value (or at least one of multiple bit values for a UE) can indicate whether the UE is to enter sleep mode or not. In this example, configuring component 452 can configure the UEs with an indication of the bit position (or multiple bit positions) for the given UE within the multiple bits, and the UE can enter sleep mode or not based on a corresponding bit value. In another example, the GTS signal may include a list of UE identifiers for UEs that are to enter sleep mode (or UEs that are not to enter sleep mode). In this example, the UE can obtain the list and enter sleep mode when an identifier for the UE is in the list (or is not in the list depending on whether the list is for UEs to enter sleep mode or not enter sleep mode).

In method 500, at Block 502, a GTS signal can be received, during a DRX active time, in a group-based DCI indicating to enter a sleep mode at the UE. In an aspect, DRX component 354, e.g., in conjunction with processor(s) 312, memory 316, transceiver 302, UE communicating component 342, etc., can receive, during the DRX active time, the GRS signal in the group-based DCI indicating to enter the sleep mode at the UE (e.g., UE 104). For example, DRX component 354 can configure the DRX active time based on a DRX configuration received from the network node, and can operate in the DRX active time by activating certain resources, as described. In another example, DRX component 354 can activate the resources for the DRX active time based on receiving a WUS, as described above and further herein.

In method 500, at Block 504, the sleep mode can be entered during at least a period of a remaining portion of the DRX active time based on receiving the GTS signal. In an aspect, DRX component 354, e.g., in conjunction with processor(s) 312, memory 316, transceiver 302, UE communicating component 342, etc., can enter, based on receiving the GTS signal, the sleep mode during at least the period of the remaining portion of the DRX active time. For example, DRX component 354 can enter the sleep mode at least in part by deactivating or reducing power to certain resources, such as RF components, power amplifiers, baseband processors, etc., as described above, as similarly performed when transitioning to a DRX inactive time during a DRX cycle. In this regard, power savings can be achieved by the UE remaining active for less than the entire DRX active time. For example, DRX component 354 can process the GTS signal to determine whether the GTS signal indicates that the UE 104 is to enter sleep mode or node (e.g., based on detecting a bit value corresponding to the UE 104, based on detecting an identifier of the UE 104 in a list of identifiers (or not), etc., as described above and further herein).

In method 600, optionally at Block 606, a WUS can be transmitted, before the DRX active time, in a previous group-based DCI indicating to exit the sleep mode at the UE for the DRX active time. In an aspect, DRX controlling component 454, e.g., in conjunction with processor(s) 412, memory 416, transceiver 402, BS communicating component 442, etc., can transmit, before the DRX active time, a WUS in a previous group-based DCI (e.g., prior to the group-based DCI including the GTS signal) indicating to exit the sleep mode at the UE for the DRX active time. For example, the WUS can be provided for further power savings by allowing the UE to maintain sleep mode through some DRX active times (e.g., where WUS is not received for the DRX active time). In this example, the WUS can be transmitted in the previous group-based DCI indicating to activate resources for the DRX active time, and the GTS signal can be transmitted during the DRX active time to allow the UE to transition to sleep mode for at least a period of a remaining portion of the DRX active time. For example, DRX controlling component 454 can generate and/or transmit the GTS signal to instruct at least a subset of the UEs, for which the WUS indicated to activate resources for the DRX active time, to deactivate the resources for at least a period of a remaining portion of the DRX active time.

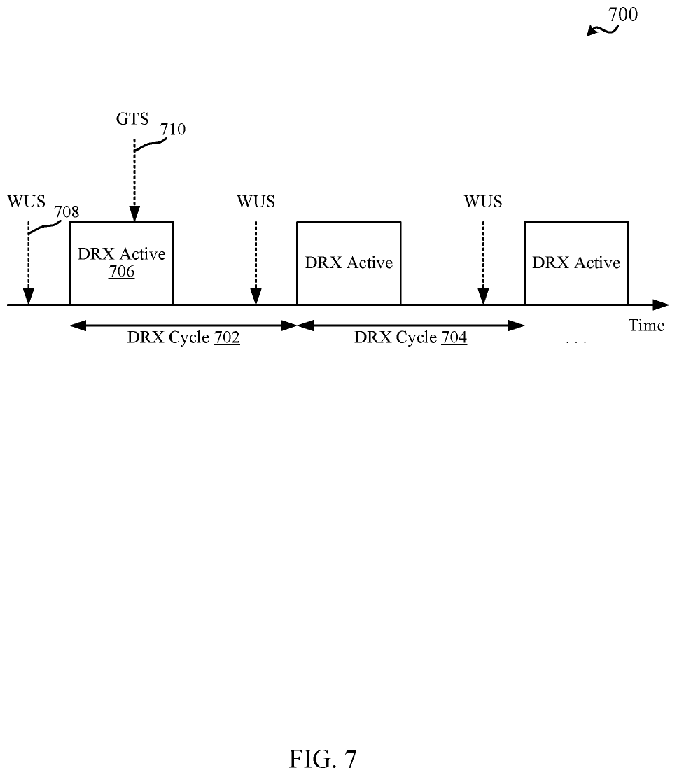

In method 500, optionally at Block 506, a WUS can be received, before the DRX active time, in a previous group-based DCI indicating to exit the sleep mode at the UE for the DRX active time. In an aspect, DRX component 354, e.g., in conjunction with processor(s) 312, memory 316, transceiver 302, UE communicating component 342, etc., can receive, before the DRX active time, the WUS in the previous group-based DCI (e.g., prior to the group-based DCI including the GTS signal) indicating to exit the sleep mode at the UE for the DRX active time. For example, the WUS can be received in the previous group-based DCI indicating to activate resources for the DRX active time, and the GTS signal can be received during the DRX active time to allow the UE to transition to sleep mode for at least a period of a remaining portion of the DRX active time. An example is shown in FIG. 7.

FIG. 7 illustrates an example of a timeline 700 of multiple DRX cycles, in accordance with aspects described herein. For example, timeline 700 includes DRX cycles 702, 704, which can each have a DRX active time (e.g., a DRX active time) where a UE has active resources for wireless communications, such as DRX active time 706, and the remainder of the DRX cycle can be a DRX inactive time, where the UE can enter sleep mode or otherwise deactivate or reduce power to certain resources for power savings. As described, timeline 700 can also include a WUS that may (or may not) be transmitted before a corresponding DRX active time, such as WUS 708 before DRX active time 706. The WUS 708, if present, can indicate (e.g., to at least a set of one or more UEs) to activate resources for the DRX active time 706. If the WUS 708 is not present, or does not indicate one or more UEs, the UEs not indicated can refrain from activating resources in the DRX active time 706 to further conserve power. In addition, in timeline 700, a GTS signal can optionally be transmitted during the DRX active time, such as GTS signal 710 in DRX active time 706, to indicate for one or more UEs to enter sleep mode for at least a period of a remaining portion of the DRX active time 706 (e.g., a period of the portion after the GTS signal 710 is transmitted or received). For example, the GTS signal 710 may indicate this for at least a subset of the UEs indicated to wake up by the WUS 708.

In one specific example, the WUS 708 can be a DCI format 2_6, as described above, which UEs can monitor during a duration of the DRX inactive time to determine whether to wake up for the DRX active time 706. In an example, the network node can utilize the WUS DCI format 2_6 during the DRX active time, and the UE(s) can monitor for and/or receive the WUS DCI format 2_6 during the DRX active time, which can alternatively indicate to a subset of the group of UEs that were woken up by the WUS DCI 2_6 708 received outside the DRX active time 706 to enter to sleep mode (e.g., go to sleep (GTS) DCI) or to skip the remaining part of the DRX active time 706 or to move the UE to a low power saving mode (e.g., such as by moving to dormancy state or low monitoring for PDCCH and channel state information (CSI) monitoring). In one specific example, the WUS 708 can indicate to wake up UE1, UE2, UE3, UE4, and the GTS signal 710 can indicate UE3 and UE4 to enter sleep mode for the remainder of DRX active time 706).

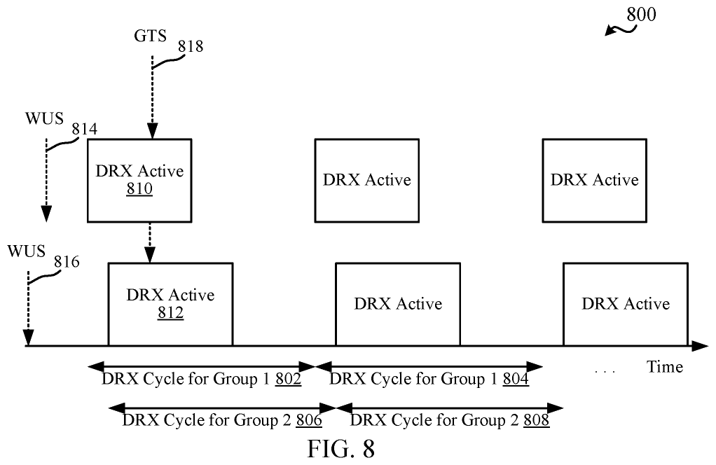

FIG. 8 illustrates an example of a timeline 800 of multiple DRX cycles for multiple groups of UEs, in accordance with aspects described herein. For example, timeline 800 includes DRX cycles 802, 804, for a first group of one or more UEs (Group 1) and DRX cycles 806, 808, for a second group of one or more UEs (Group 2). For example, the DRX cycles 802, 804 for the Group 1 can include DRX active times, such as DRX active time 810, where UE(s) in Group 1 have active resources for wireless communications, and the remainder of the DRX cycle can be a DRX inactive time. For example, the DRX cycles 806, 808 for the Group 2 can include DRX active times, such as DRX active time 812, where UE(s) in Group 2 have active resources for wireless communications, and the remainder of the DRX cycle can be a DRX inactive time. Timeline 800 can also include a WUS 814 for Group 1 that may (or may not) be transmitted before a corresponding DRX active time 810, and can indicate (e.g., to the UE(s) in Group 1) to activate resources for the DRX active time 810. Timeline 800 can also include a WUS 816 for Group 2 that may (or may not) be transmitted before a corresponding DRX active time 812, and can indicate (e.g., to the UE(s) in Group 2) to activate resources for the DRX active time 812.

In this example, timeline 800 can include a GTS signal 818 transmitted during the DRX active times 810 and 812 to indicate for one or more UEs to enter sleep mode for at least a period of a remaining portion of the DRX active time. For example, the one or more UEs indicated in the GTS signal 818 can include one or more UEs from Group 1 (which are indicated to sleep for a period of the portion DRX active time 810 after the GTS signal 818 is transmitted or received), and/or can include one or more UEs from Group 2 (which are indicated to sleep for a period of the portion DRX active time 812 after the GTS signal 818 is transmitted or received). For example, each group of UEs can be associated with a corresponding DRX configuration or DRX active time, so the UEs may be DRX aligned or have different DRX on time, but the same group-based DCI for GTS signal can be used to put a subset of all UEs to sleep. In WUS 814 and 816, both groups of UEs can be indicated to monitor this GTS 818, as described above and further herein, or to skip PDCCH DCI. Moreover, as described, configuration of the group of UEs, the resources for WUS and/or GTS signals, etc., can be done using RRC signaling, MACE-CE, DCI, etc. Thus, for example, the GTS signal 818 can be a supergroup DCI of the two groups, where both groups can monitor this new GTS DCI, or in other words, for example, both (or multiple) groups of UEs can monitor and receive the same GTS or group common PDCCH skipping DCI (to skip portion or full remaining DRX of corresponding group).

In one example, the group-based DCI for the GTS signal can have same or similar properties or parameters as the previous group-based DCI for the WUS, and in such examples, configuration processing component 352 can obtain the properties or parameters for the group-based DCI for the GTS signal based on those for the previous group-based DCI for the WUS. For example, configuration processing component 352 can receive a configuration for the WUS (e.g., a RRC configuration, a MAC-CE or DCI indicating or activating configuration parameters, etc.) from the network node, which can indicate one or more properties or parameters for receiving the WUS. For example, the group-based DCI for the GTS signal can have a same time and/or frequency allocation (e.g., relative to, or as offset from, a slot boundary) as the previous group-based DCI, same control resource set (CORESET) information, same aggregation level (AL) information, etc. for the WUS, and in this example, configuration processing component 352 can determine the time and/or frequency resources, CORESET information, AL information, etc. over which to receive the GTS signal based on the time and/or frequency resources, CORESET information, AL information, allocated for the WUS.

In another example, the group-based DCI for the GTS signal can have same or similar search space parameters (e.g., search space set), RNTI, etc., as the previous group-based DCI for the WUS, and in such examples, configuration processing component 352 can obtain the search space parameters (e.g., search space set), RNTI, etc., for the group-based DCI for the GTS signal based on those for the previous group-based DCI for the WUS. In addition, in an example, the group-based DCI for the GTS signal can be associated with, or otherwise linked or connected to, the previous group-based DCI for the WUS, which can be based on an identifier or other parameters or properties of the DCI or signaling thereof, etc., linking the DCIs.

In method 500, optionally at Block 508, at least one of a search space for the group-based DCI or a RNTI for the group-based DCI can be derived based on at least one of a previous search space for the previous group-based DCI or a previous RNTI for the previous group-based DCI. In an aspect, configuration processing component 352, e.g., in conjunction with processor(s) 312, memory 316, transceiver 302, UE communicating component 342, etc., can derive at least one of the search space for the group-based DCI (e.g., for the GTS signal) or a RNTI for the group-based DCI based on at least one of the previous search space for the previous group-based DCI (e.g., for the WUS) or a previous RNTI for the previous group-based DCI. In one example, the group-based DCI for the GTS signal can have a same search space and RNTI as the WUS DCI format 2_6, and configuration processing component 352 can determine the search space and RNTI for the GTS signal based on those configured for the WUS DCI format 2_6. In another example, the group-based DCI for the GTS signal can have a limited search space inferred from the previous search space for WUS DCI format 2_6 and a same or different RNTI, and configuration processing component 352 can derive the search space from that for the WUS DCI format 2 6, and/or can use the same RNTI or receive a RNTI dedicated to GTS signals in a configuration from the network node. In another example, the group-based DCI for the GTS signal can have a new search space or new time/frequency resource allocation different from the previous search space for WUS DCI format 2_6 and a same or different RNTI, and configuration processing component 352 can obtain the search space or time/frequency resource allocation and/or RNTI dedicated to GTS signals in a configuration from the network node.

In method 600, optionally at Block 610, a configuration indicating one or more configuration parameters for the group-based DCI or the GTS signal can be transmitted. In an aspect, configuring component 452, e.g., in conjunction with processor(s) 412, memory 416, transceiver 402, BS communicating component 442, etc., can transmit the configuration indicating the one or more configuration parameters for the group-based DCI or the GTS signal. For example, configuring component 452 can transmit the configuration as an RRC configuration for the GTS signal, as part of the WUS, etc.

In method 500, optionally at Block 510, a configuration indicating one or more configuration parameters for the group-based DCI or the GTS signal can be received. In an aspect, configuration processing component 352, e.g., in conjunction with processor(s) 312, memory 316, transceiver 302, UE communicating component 342, etc., can receive and/or process the configuration indicating the one or more configuration parameters for the group-based DCI or the GTS signal. For example, configuration processing component 352 can receive the configuration as an RRC configuration for the GTS signal, as part of the WUS, etc. For example, the GTS signal can be a WUS (or at least a DCI format 2_6 in a similar search space) where one bit in a WUS may indicate that WUS is a GTS DCI (e.g., as a mode of operation defined in the wireless communication technology or in RRC/MAC-CE where UE can expect to use WUS 2_6 for such operation or another new DCI). In another example, the WUS can indicate a time and/or frequency allocation for GTS signal, such that no blind decoding may be required. In this example, configuring component 452 can specify, in the WUS, the time and/or frequency allocation for the GTS signal, such as using parameters within the WUS, one or more properties of the WUS, etc. In this example, configuration processing component 352 can determine the time and/or frequency allocation for the GTS signal based on the WUS.

In another example, the WUS can indicate a minimum time offset from WUS to GTS signal. In this example, configuring component 452 can specify, in the WUS, the minimum time offset from WUS to GTS signal, such as using parameters within the WUS, one or more properties of the WUS, etc. In this example, configuration processing component 352 can determine the minimum time offset from WUS to GTS signal based on the WUS, and can monitor for the GTS signal during the time offset from receiving the WUS or at least during the DRX active time. In another example, configuring component 452 can transmit, to the UE, a configuration (e.g., RRC/MAC-CE configuration) that indicates the time offset, and configuration processing component 352 can receive the configuration and determine the time offset based on the configuration.

In yet another example, the WUS can indicate whether the UE can expect to receive the GTS signal in the current DRX active time corresponding to the WUS. IN this example, configuring component 452 can specify, in the WUS, the indication of whether the UE can expect to receive the GTS signal in the current DRX active time corresponding to the WUS, such as using parameters within the WUS, one or more properties of the WUS, etc. In this example, configuration processing component 352 can determine, based on the indication in the WUS, whether to monitor the DRX active time for the GTS signal.

As described, for example, the GTS signal can have a different configuration from the WUS configuration, where the different configuration can indicate one or more of a search space for the GTS signal, a time and/or frequency resource location for the GTS signal, a payload size of the GTS signal, a time offset to at least expect to monitor the GTS DCI, etc. For example, the configuration can be part of the last WUS or in RRC signaling, MAC-CE, another DCI or layer 1 (L1) indication, a combination thereof, etc. For example, configuring component 452 can transmit the different configuration in the last WUS, in RRC signaling, in MAC-CE, in another DCI or L1 indication, and/or the like, and configuration processing component 352 can receive the configuration and accordingly determine parameters for receiving the GTS signal, as described above.

In another example, while configuring GTS signal, as in WUS DCI format 2_6 where the network node can use RRC configuration to configure DCI format 2_6, the network node can indicate, to each UE, the bits to check in the GTS signal and/or what the bits indicate (e.g., the bits to check as time offset, time and/or frequency allocation, control resource set (CORESET) info, aggregation level (AL), etc.). In one example, the configuration of WUS DCI format 2_6 can have two branches: one for DCI format 2_6 received during outside DRX active time (e.g., for the WUS) and the other is DCI format 2_6 received inside DRX active time (e.g., for the GTS signal).

In this example, in method 600, optionally at Block 612, a configuration indicating which bits of the group-based DCI correspond to the GTS signal for the UE can be transmitted. In an aspect, configuring component 452, e.g., in conjunction with processor(s) 412, memory 416, transceiver 402, BS communicating component 442, etc., can transmit the configuration indicating which bits of the group-based DCI correspond to the GTS signal for the UE. For example, DRX controlling component 454 can transmit the GTS signal to indicate GTS parameters for each of multiple UEs, and configuring component 452 can accordingly configure each UE with information regarding which bits are for that UE and/or what the bits indicate.

In method 500, optionally at Block 512, a configuration indicating which bits of the group-based DCI correspond to the GTS signal for the UE can be received. In an aspect, configuration processing component 352, e.g., in conjunction with processor(s) 312, memory 316, transceiver 302, UE communicating component 342, etc., can receive and/or process the configuration indicating which bits of the group-based DCI correspond to the GTS signal for the UE. For example, DRX component 354 can use the configuration information to determine which bits of the group-based DCI relate to the UE, the meaning of the bits, and can accordingly process the GTS signal, as described above, to determine the time offset between the WUS and GTS signal, which resources correspond to the UE, which CORESET to use to receive or process the GTS signal, which AL to use to decode the GTS signal and/or corresponding DCI from the search space, etc.

FIG. 9 is a block diagram of a MIMO communication system 900 including a base station 102 and a UE 104. The MIMO communication system 900 may illustrate aspects of the wireless communication access network 100 described with reference to FIG. 1. The base station 102 may be an example of aspects of the base station 102 described with reference to FIG. 1. The base station 102 may be equipped with antennas 934 and 935, and the UE 104 may be equipped with antennas 952 and 953. In the MIMO communication system 900, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 920 may receive data from a data source. The transmit processor 920 may process the data. The transmit processor 920 may also generate control symbols or reference symbols. A transmit MIMO processor 930 may perform spatial processing (e.g., precoding) on data symbols, control symbols, or reference symbols, if applicable, and may provide output symbol streams to the transmit modulator/demodulators 932 and 933. Each modulator/demodulator 932 through 933 may process a respective output symbol stream (e.g., for OFDM, etc.) to obtain an output sample stream. Each modulator/demodulator 932 through 933 may further process (e.g., convert to analog, amplify, filter, and upconvert) the output sample stream to obtain a DL signal. In one example, DL signals from modulator/demodulators 932 and 933 may be transmitted via the antennas 934 and 935, respectively.

The UE 104 may be an example of aspects of the UEs 104 described with reference to FIGS. 1 and 3. At the UE 104, the UE antennas 952 and 953 may receive the DL signals from the base station 102 and may provide the received signals to the modulator/demodulators 954 and 955, respectively. Each modulator/demodulator 954 through 955 may condition (e.g., filter, amplify, downconvert, and digitize) a respective received signal to obtain input samples. Each modulator/demodulator 954 through 955 may further process the input samples (e.g., for OFDM, etc.) to obtain received symbols. A MIMO detector 956 may obtain received symbols from the modulator/demodulators 954 and 955, perform MIMO detection on the received symbols, if applicable, and provide detected symbols. A receive (Rx) processor 958 may process (e.g., demodulate, deinterleave, and decode) the detected symbols, providing decoded data for the UE 104 to a data output, and provide decoded control information to a processor 980, or memory 982.

The processor 980 may in some cases execute stored instructions to instantiate a UE communicating component 342 (see e.g., FIGS. 1 and 3).

On the uplink (UL), at the UE 104, a transmit processor 964 may receive and process data from a data source. The transmit processor 964 may also generate reference symbols for a reference signal. The symbols from the transmit processor 964 may be precoded by a transmit MIMO processor 966 if applicable, further processed by the modulator/demodulators 954 and 955 (e.g., for single carrier-FDMA, etc.), and be transmitted to the base station 102 in accordance with the communication parameters received from the base station 102. At the base station 102, the UL signals from the UE 104 may be received by the antennas 934 and 935, processed by the modulator/demodulators 932 and 933, detected by a MIMO detector 936 if applicable, and further processed by a receive processor 938. The receive processor 938 may provide decoded data to a data output and to the processor 940 or memory 942.

The processor 940 may in some cases execute stored instructions to instantiate a BS communicating component 442 (see e.g., FIGS. 1 and 4).

The components of the UE 104 may, individually or collectively, be implemented with one or more ASICs adapted to perform some or all of the applicable functions in hardware. Each of the noted modules may be a means for performing one or more functions related to operation of the MIMO communication system 900. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 900.

The following aspects are illustrative only and aspects thereof may be combined with aspects of other embodiments or teaching described herein, without limitation.
Aspect 1 is a method for wireless communication at a UE including receiving, during a DRX active time, a GTS signal in a group-based DCI indicating to enter a sleep mode at the UE, and entering, based on receiving the GTS signal, the sleep mode during at least a period of a remaining portion of the DRX active time.
In Aspect 2, the method of Aspect 1 includes receiving, before the DRX active time, a wake-up signal in a previous group-based DCI indicating to exit the sleep mode at the UE for the DRX active time.
In Aspect 3, the method of Aspect 2 includes where the group-based DCI and the previous group-based DCI have a same time and frequency resource allocation within respective time periods.
In Aspect 4, the method of any of Aspects 2 or 3 includes where the group-based DCI and the previous group-based DCI have a same aggregation level.
In Aspect 5, the method of any of Aspects 2 to 4 includes where the group-based DCI and the previous group-based DCI are in a same search space set and are scrambled with a same RNTI.
In Aspect 6, the method of any of Aspects 2 to 5 includes deriving at least one of a search space for the group-based DCI or a RNTI for the group-based DCI based on at least one of a previous search space for the previous group-based DCI or a previous RNTI for the previous group-based DCI.
In Aspect 7, the method of any of Aspects 2 to 6 includes where the GTS signal is of a same format as the wake-up signal and includes an indicator that the GTS signal is for indicating to enter the sleep mode.
In Aspect 8, the method of any of Aspects 2 to 7 includes where the wake-up signal indicates a time and frequency resource allocation for the GTS signal, and where receiving the GTS signal is based on the time and frequency resource allocation.
In Aspect 9, the method of any of Aspects 2 to 8 includes where the wake-up signal indicates a minimum time offset between the wake-up signal and the GTS signal.
In Aspect 10, the method of any of Aspects 2 to 9 includes receiving a configuration indicating a minimum time offset between the wake-up signal and the GTS signal.
In Aspect 11, the method of any of Aspects 2 to 10 includes where the wake-up signal indicates one or more configuration parameters for the group-based DCI, where the one or more configuration parameters include one or more of a search space, a time and frequency resource location, a radio network temporary identifier, a payload size, or a time offset for monitoring the group-based DCI.
In Aspect 12, the method of any of Aspects 1 to 11 includes receiving a configuration that indicates one or more configuration parameters for the group-based DCI, where the one or more configuration parameters include one or more of a search space, a time and frequency resource location, a radio network temporary identifier, a payload size, or a time offset for monitoring the group-based DCI.
In Aspect 13, the method of Aspect 12 includes where receiving the configuration is in one or more of RRC signaling, a MAC-CE, a different DCI or L1 indication.
In Aspect 14, the method of any of Aspects 1 to 13 includes receiving a configuration indicating which bits of the group-based DCI correspond to the GTS signal for the UE.
In Aspect 15, the method of Aspect 14 includes where the configuration indicates the bits for one or more of a time offset, a time and frequency resource allocation, CORESET information, or an aggregation level for the GTS signal.
In Aspect 16, the method of any of Aspects 14 or 15 includes where the configuration includes a first branch indicating which bits of the group-based DCI correspond to the GTS signal for the UE, and a second branch indicating which bits of a second group-based DCI received outside of the DRX active time correspond to a wake-up signal for the UE.
Aspect 17 is a method for wireless communication at a network node including configuring a UE to communicate in a DRX active time, and transmitting, during the DRX active time, a GTS signal in a group-based DCI indicating to enter a sleep mode at the UE.
In Aspect 18, the method of Aspect 17 includes transmitting, before the DRX active time, a wake-up signal in a previous group-based DCI indicating to exit the sleep mode at the UE for the DRX active time.
In Aspect 19, the method of Aspect 18 includes where the DCI and the previous DCI have a same time and frequency resource allocation within respective time periods.
In Aspect 20, the method of any of Aspects 18 or 19 includes where the DCI and the previous DCI have a same aggregation level.
In Aspect 21, the method of any of Aspects 18 to 20 includes where the DCI and the previous DCI are in a same search space set and are scrambled with a same RNTI.
In Aspect 22, the method of any of Aspects 18 to 21 includes where the GTS signal is of a same format as the wake-up signal and includes an indicator that the GTS signal is for indicating to enter the sleep mode.
In Aspect 23, the method of any of Aspects 18 to 22 includes where the wake-up signal indicates a time and frequency resource allocation for the GTS signal.
In Aspect 24, the method of any of Aspects 18 to 23 includes where the wake-up signal indicates a minimum time offset between the wake-up signal and the GTS signal.
In Aspect 25, the method of any of Aspects 18 to 24 includes transmitting a configuration indicating a minimum time offset between the wake-up signal and the GTS signal.
In Aspect 26, the method of any of Aspects 18 to 25 includes where the wake-up signal indicates one or more configuration parameters for the DCI, where the one or more configuration parameters include one or more of a search space, a time and frequency resource location, a radio network temporary identifier, a payload size, or a time offset for monitoring the DCI.
In Aspect 27, the method of any of Aspects 17 to 26 includes transmitting a configuration that indicates one or more configuration parameters for the DCI, where the one or more configuration parameters include one or more of a search space, a time and frequency resource location, a radio network temporary identifier, a payload size, or a time offset for monitoring the DCI.
In Aspect 28, the method of Aspect 27 includes where transmitting the configuration is in one or more of RRC signaling, a MAC-CE, a different DCI or L1 indication.
In Aspect 29, the method of any of Aspects 17 to 28 includes transmitting a configuration indicating which bits of the group-based DCI correspond to the GTS signal for the UE.
In Aspect 30, the method of Aspect 29 includes where the configuration indicates the bits for one or more of a time offset, a time and frequency resource allocation, CORESET information, or an aggregation level for the GTS signal.
In Aspect 31, the method of any of Aspects 29 or 30 includes where the configuration includes a first branch indicating which bits of the group-based DCI correspond to the GTS signal for the UE, and a second branch indicating which bits of a second group-based DCI transmitted outside of the DRX active time correspond to a wake-up signal for the UE.
Aspect 32 is an apparatus for wireless communication including a processor, memory coupled with the processor, and instructions stored in the memory and operable, when executed by the processor, to cause the apparatus to perform any of the methods of Aspects 1 to 31.
Aspect 33 is an apparatus for wireless communication including means for performing any of the methods of Aspects 1 to 31.
Aspect 34 is a computer-readable medium including code executable by one or more processors for wireless communications, the code including code for performing any of the methods of Aspects 1 to 31.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a processor;
memory coupled with the processor; and
instructions stored in the memory and operable, when executed by the processor, to cause the apparatus to:
receive, during a discontinuous receive (DRX) active time, a go to sleep (GTS) signal in a group-based downlink control information (DCI) indicating to enter a sleep mode at the apparatus; and
enter, based on receiving the GTS signal, the sleep mode during at least a period of a remaining portion of the DRX active time.

2. The apparatus of claim 1, wherein the instructions, when executed by the processor, cause the apparatus to receive, before the DRX active time, a wake-up signal in a previous group-based DCI indicating to exit the sleep mode at the apparatus for the DRX active time.

3. The apparatus of claim 2, wherein the group-based DCI and the previous group-based DCI have a same time and frequency resource allocation within respective time periods.

4. The apparatus of claim 2, wherein the group-based DCI and the previous group-based DCI have a same aggregation level.

5. The apparatus of claim 2, wherein the group-based DCI and the previous group-based DCI are in a same search space set and are scrambled with a same radio network temporary identifier (RNTI).

6. The apparatus of claim 2, wherein the instructions, when executed by the processor, cause the apparatus to derive at least one of a search space for the group-based DCI or a radio network temporary identifier (RNTI) for the group-based DCI based on at least one of a previous search space for the previous group-based DCI or a previous RNTI for the previous group-based DCI.

7. The apparatus of claim 2, wherein the GTS signal is of a same format as the wake-up signal and includes an indicator that the GTS signal is for indicating to enter the sleep mode.

8. The apparatus of claim 2, wherein the wake-up signal indicates a time and frequency resource allocation for the GTS signal, and wherein the instructions, when executed by the processor, cause the apparatus to receive the GTS signal based on the time and frequency resource allocation.

9. The apparatus of claim 2, wherein the wake-up signal indicates a minimum time offset between the wake-up signal and the GTS signal.

10. The apparatus of claim 2, wherein the instructions, when executed by the processor, cause the apparatus to receive a configuration indicating a minimum time offset between the wake-up signal and the GTS signal.

11. The apparatus of claim 2, wherein the wake-up signal indicates one or more configuration parameters for the group-based DCI, wherein the one or more configuration parameters include one or more of a search space, a time and frequency resource location, a radio network temporary identifier, a payload size, or a time offset for monitoring the group-based DCI.

12. The apparatus of claim 1, wherein the instructions, when executed by the processor, cause the apparatus to receive a configuration that indicates one or more configuration parameters for the group-based DCI, wherein the one or more configuration parameters include one or more of a search space, a time and frequency resource location, a radio network temporary identifier, a payload size, or a time offset for monitoring the group-based DCI.

13. The apparatus of claim 12, wherein the instructions, when executed by the processor, cause the apparatus to receive the configuration in one or more of radio resource control (RRC) signaling, a media access control-control element (MAC-CE), a different DCI or layer 1 (L1) indication.

14. The apparatus of claim 1, wherein the instructions, when executed by the processor, cause the apparatus to receive a configuration indicating which bits of the group-based DCI correspond to the GTS signal for the apparatus.

15. The apparatus of claim 14, wherein the configuration indicates the bits for one or more of a time offset, a time and frequency resource allocation, control resource set (CORESET) information, or an aggregation level for the GTS signal.

16. The apparatus of claim 14, wherein the configuration includes a first branch indicating which bits of the group-based DCI correspond to the GTS signal for the apparatus, and a second branch indicating which bits of a second group-based DCI received outside of the DRX active time correspond to a wake-up signal for the apparatus.

17. An apparatus for wireless communication, comprising:
a processor;
memory coupled with the processor; and
instructions stored in the memory and operable, when executed by the processor, to cause the apparatus to:
configure a user equipment (UE) to communicate in a discontinuous receive (DRX) active time; and
transmit, during the DRX active time, a go to sleep (GTS) signal in a group-based downlink control information (DCI) indicating to enter a sleep mode at the UE.

18. The apparatus of claim 17, wherein the instructions, when executed by the processor, cause the apparatus to transmit, before the DRX active time, a wake-up signal in a previous group-based DCI indicating to exit the sleep mode at the UE for the DRX active time.

19. The apparatus of claim 18, wherein the DCI and the previous DCI at least one of have a same time and frequency resource allocation within respective time periods, have a same aggregation level, or are in a same search space set and are scrambled with a same radio network temporary identifier (RNTI).

20. The apparatus of claim 18, wherein the GTS signal is of a same format as the wake-up signal and includes an indicator that the GTS signal is for indicating to enter the sleep mode.

21. The apparatus of claim 18, wherein the wake-up signal indicates at least one of a time and frequency resource allocation for the GTS signal, or a minimum time offset between the wake-up signal and the GTS signal.

22. The apparatus of claim 18, wherein the instructions, when executed by the processor, cause the apparatus to transmit a configuration indicating a minimum time offset between the wake-up signal and the GTS signal.

23. The apparatus of claim 18, wherein the wake-up signal indicates one or more configuration parameters for the DCI, wherein the one or more configuration parameters include one or more of a search space, a time and frequency resource location, a radio network temporary identifier, a payload size, or a time offset for monitoring the DCI.

24. The apparatus of claim 17, wherein the instructions, when executed by the processor, cause the apparatus to transmit a configuration that indicates one or more configuration parameters for the DCI, wherein the one or more configuration parameters include one or more of a search space, a time and frequency resource location, a radio network temporary identifier, a payload size, or a time offset for monitoring the DCI, and wherein transmitting the configuration is in one or more of radio resource control (RRC) signaling, a media access control-control element (MAC-CE), a different DCI or layer 1 (L1) indication.

25. The apparatus of claim 17, wherein the instructions, when executed by the processor, cause the apparatus to transmit a configuration indicating which bits of the group-based DCI correspond to the GTS signal for the UE.

26. The apparatus of claim 25, wherein the configuration at least one of indicates the bits for one or more of a time offset, a time and frequency resource allocation, control resource set (CORESET) information, or an aggregation level for the GTS signal.

27. The apparatus of claim 25, wherein the configuration includes a first branch indicating which bits of the group-based DCI correspond to the GTS signal for the UE, and a second branch indicating which bits of a second group-based DCI transmitted outside of the DRX active time correspond to a wake-up signal for the UE.

28. A method for wireless communication at a user equipment (UE), comprising:
receiving, during a discontinuous receive (DRX) active time, a go to sleep (GTS) signal in a group-based downlink control information (DCI) indicating to enter a sleep mode at the UE; and
entering, based on receiving the GTS signal, the sleep mode during at least a period of a remaining portion of the DRX active time.

29. The method of claim 28, further comprising receiving, before the DRX active time, a wake-up signal in a previous group-based DCI indicating to exit the sleep mode at the UE for the DRX active time.

30. A method for wireless communication at a network node, comprising:
configuring a user equipment (UE) to communicate in a discontinuous receive (DRX) active time; and
transmitting, during the DRX active time, a go to sleep (GTS) signal in a group-based downlink control information (DCI) indicating to enter a sleep mode at the UE.
